(19) United States
(12) Patent Application Publication
(10) Pub. No.: US 2026/0218431 A1
(43) Pub. Date: Jul. 30, 2026

(54) TREATMENT CABINET

(71) Applicant: IMBOX PROTECTION A/S, Skødstrup (DK)

(72) Inventor: René Charles MARKER, Aarhus C (DK)

(21) Appl. No.: 19/147,301

(22) PCT Filed: Jan. 23, 2024
(86) PCT No.: PCT/DK2024/050010

§ 371 Date: Jul. 10, 2025

(30) Foreign Application Priority Data
Jan. 23, 2023 (DK) PA202370035

(51) Int. Cl. D06B 1/02; B05B 12/12; B05B 13/04; B05B 16/60; D06B 5/24; D06F 43/00

(52) U.S. Cl. CPC D06B 1/02; B05B 12/122; B05B 13/041; B05B 16/60; D06B 5/24; D06F 43/007

(57) ABSTRACT

A treatment cabinet is provided, including four sidewalls, a top and a bottom enclosing a treatment volume, wherein at least one side wall is openable, allowing access to the treatment volume, where on the inside of a sidewall facing the treatment volume a spraying device is arranged, the spraying device including a rail onto which rail at least one spraying head is movably mounted such that the spraying head may move along the rail, and where the spraying head comprises two or more nozzles adapted to issue a liquid, gas or mist of a treatment agent, and further that the rail may move between the top and bottom, guided by side rails arranged parallel to the sidewall, and where means are provided for suspending or supporting a garment inside the treatment volume.

### CROSS REFERENCE TO RELATED APPLICATIONS

This application is a national stage of PCT Application No. PCT/DK2024/050010, having a filing date of Jan. 23, 2024, which is based on DK Application No. PA202370035, having a filing date of Jan. 23, 2023, the entire contents both of which are hereby incorporated by reference.

### FIELD OF TECHNOLOGY

The following is related to a treatment cabinet. The treatment cabinet is specifically designed for treatment of garments such as for example coats, jackets, jeans, trousers and other large pieces of wearable garments, which it is desirable to provide with a surface treatment as will be explained further below. The following is also related to a method of treating a garment using such a treatment cabinet.

In the following, reference will be made to a garment in the shape of a coat, but it should be understood that any type of garment suitable to have a surface treatment, will be suitable to use with embodiments of the present invention.

### BACKGROUND

In the art, it is well known to clean or wash garments and subsequently treat them with a surface treatment such as for example an impregnation in order to render the garments clean and resistant for ingress of moisture. This is typically carried out by using a washing machine and subsequently manually using a spray can in order to apply the desired surface treatment. This of course is an inadequate process in many instances, but it also entails a number of drawbacks, for example a washing routine for coats which are only marginally dirty, is a waste of water, energy and provides excessive wear on the article without this really being necessary. Also, a standard washing cycle creates waste water which is polluted with various chemicals, which requires careful handling and further expensive treatment before such waste water is considered harmless to the environment. Furthermore, the manual impregnation method by using spray cans is not an environmentally friendly manner in which to impregnate items and at the same time a substantial amount of the issued impregnating substance is not directed to the correct places on the garment but may end up in the ambient environment resulting in an excessive use of impregnating agent. As most impregnating agents contain substances which are more or less harmful to the environment, this is of course an undesired side effect.

For other treatments, such as for example dry wash, anti-static, or insect repellent, similar considerations apply to the prior art methods, for example as described above.

### SUMMARY

An aspect relates to a manner in which to impregnate in an environmentally safe manner and with a minimum use of energy and tear and wear on the garment being treated to provide a cleaning and surface treatment process. Also, the impregnation of the garment shall be improved such that impregnation agent is directed mainly at desired areas, with a minimum of waste.

Embodiments of the present invention address this by providing a treatment cabinet comprising four sidewalls, a top and a bottom enclosing a treatment volume, wherein at least one side wall is openable, allowing access to the treatment volume, where on the inside of a sidewall facing the treatment volume a spraying device is arranged, the spraying device comprising a rail onto which rail at least one spraying head is movably mounted such that the spraying head may move along the rail, and where the spraying head comprises two or more nozzles adapted to issue a liquid, gas or mist of a treatment agent, and further that the rail may move between the top and bottom, guided by side rails arranged parallel to the sidewall, and where means are provided for suspending or supporting a garment inside the treatment volume.

Embodiments of the invention provide a closed cabinet inside which the treatment takes place makes sure that the treatment is carried out in a controlled environment. In this context, controlled environment means that, for example, temperature, relative humidity, wind speed, etc. may be controlled. Furthermore, the issued impregnating agent or other treatment agent may in a controlled manner be handled inside the treatment volume, and extracted in a safe manner, such that any detrimental impact on the environment is minimized. Furthermore, the escape of potentially damaging compounds to the ambient environment is minimized or avoided all together. Furthermore, by providing rails on which one or more spray heads comprising two or more nozzles travel, the garment to be treated is more or less surrounded at a very closed distance by the nozzles issuing the treatment compound. The nozzles may move in what in use will be a substantially horizontal plane whereas the rails on which the nozzles are mounted may move in a vertical direction. In this manner it is possible to position the nozzles issuing the mist at exactly the correct position relative to the garment to be treated and in such a manner assure that the entire surface of the garment is treated, and that superfluous treatment is not conducted as it is possible to map and control the position of the nozzles 100% inside the treatment cabinet.

In an embodiment of the treatment cabinet, rails with spray heads are arranged on opposing side walls, and where both sets of rails independently may be moved between the bottom and top inside the treatment volume. With this embodiment the front and rear side of the garment may be treated simultaneously and as such a more intensive treatment may be achieved.

In an embodiment, the one or two rails is/are curved, such that the rail is closest to the sidewall in a central part of the rail, and furthest away from the sidewall in the distal ends of the rail(s). In this manner it is possible to aim the spray/mist from the nozzles towards a more central part of the treatment volume, as normally the garment will not extend to the very corners of the treatment volume. In this manner a more efficient treatment using less treatment compound is provided.

In an embodiment of the invention, a grid is provided on one inner surface of a sidewall, and where a vision unit is mounted on or near an opposite side, such that the vision unit can monitor the grid. The grid in combination with a vision unit provides the possibility of detecting the extent of the garment inside the treatment cabinet and thereby use this information in order to control the travels of the nozzles issuing the treatment compound. The detection of the area or size of the garment is carried out by the vision unit being placed on one side of the garment and the grid being placed on the other side of garment such that as the vision unit is directed towards the grid only parts of the grid being visible outside the contour of the garment will be detected by the vision unit and as such used as input to a control unit which may control the travel of the nozzles (and the spraying regime).

In an embodiment, the treatment cabinet is constructed such that on one rail optionally on the spraying head, a light source is provided emitting light and where on the other rail optionally on the spraying head, a light receiver is provided. As the light source emits light and the light receiver receives the emitted light, any changes in the received light will indicate an obstruction—for example a garment arranged between the light emitter and the light receiver. A control unit will recognize the exact position of the light source and the light receiver, and in this manner, as the light source and light receiver traverse the treatment volume, recognize the shape/contour of a garment arranged inside the treatment volume, as the garment will block for the emitted light being received by the light receiver, indicating the extend of a garment.

In an embodiment of the invention a control unit is provided, the control unit is programmed with pattern recognition software such that the portion of the grid visible by the vision unit or the area where light is received or not received is used as input to a treatment agent dispenser, determining the amount of treatment agent to be used by the spraying head or heads for treating a particular garment inside the treatment volume. This control unit is used as described above in order to determine the position and extent of the garment position inside the treatment volume.

In an embodiment of the invention, the nozzles are directional and where the nozzles may be aimed at certain areas in response to instructions received from the control unit. This feature may be particularly advantageous when treating garments having different surface properties such that some parts of the garment should have extra treatment whereas other parts of the garment should not be treated at all. Likewise, it may also be desirable to, for example, when the treatment is an impregnation treatment to supply a double treatment along seams in order to render these areas particularly impervious.

In an embodiment, the vision unit includes a UV light source and where UV reactive blacklight agent is mixed with the treatment agent or one of the treatment agents before being issued from the nozzles.

In an embodiment, one or more UV light source(s) is/are provided inside the treatment cabinet. The light source(s) are/is arranged such that UV light may be directed towards all (exterior) surfaces of a garment arranged inside the treatment volume. The UV light is particularly used in connection with treatments involving substances which may be cured or hardened when exposed to UV light.

By mixing a UV reactive light agent with the treatment agent before the treatment agent being issued towards the garment it is possible to register the extent to which the treatment compound is applied to the garment by the vision unit being able to register the highlights created by the UV reactive backlight agent exposed to a UV light source. In this manner, it is possible to document that a proper treatment has occurred or to register areas of the garment which have not been treated sufficiently such that the control unit automatically may be programmed to reapply the treatment to specific surfaces or areas on the garment.

In connection with the provision of UV reactive blacklight agents mixed with the treatment agent and the provision of a UV light source inside the treatment volume and a vision unit being able to detect the highlights it is also contemplated that the exterior of the treatment cabinet may/should be provided with a screen indicating the progress and completeness of the treatment to a user from outside the treatment cabinet.

In an embodiment of the invention, ventilation and/or air agitation means are provided in communication with the treatment volume, such that air is being circulated inside the treatment volume, and air containing surplus treatment agent is ventilated away in a controlled manner.

By providing ventilation means it is possible to create a slight negative pressure relative to ambient pressure in the environment in which the treatment cabinet is placed such that it is achieved that treatment compound is not able to escape to the ambient environment. Furthermore, by having controlled ventilation means it is possible by providing suitable and adequate filtration to cleanse the air and before it leaves the treatment volume.

The agitation means may typically be a fan, often the fan provided with the ventilation means such that the air and thereby the minute particles of the treatment compound issued by the treatment nozzles may be circulated inside the treatment volume and thereby if not having being adhered to surfaces of the garment to be treated upon issuing from the nozzles may be recirculated and apply to other parts of the surface of the garment to be treated. In this manner the agitation means assure that waste is minimized, that an improved treatment may be obtained and at the same time that nonmoving or non-agitating air pockets does not arise inside the treatment volume which may be detrimental to the overall functioning of the device.

In an embodiment of the invention, preprogrammed treatment routines are provided in an operators control unit, where the preprogrammed routines may include a combination of different treatments by having the nozzles issuing a suitable agent towards the garment to be treated, where the treatments may be selected from one or more of the following:
a. Chemical cleaning comprising issuing a dry-cleaning agent onto the garment to be treated and subsequently removing the cleaning agent;
b. High pressure air jet treatment;
c. Impregnation against moisture;
d. Bug repellents;
e. anti-static treatment.

In this manner a user may position any garment which is suitable for treatment in a treatment cabinet inside the treatment volume and thereafter selecting the appropriate treatment routine example from a menu of preprogrammed treatment routines. The preprogrammed treatment routines may include a chemical cleansing, for example in combination with a high-pressure air jet treatment. The high-pressure air jet treatment may jet any chemical cleaning agent and at the same time remove any dust and other unwanted debris from the garment to be treated. This will prepare the garment for the application of, for example an impregnating agent onto a substantially clean surface which will improve the overall result. It is also foreseen that the treatment may be a bug repellant treatment where the bug repellant chemical is issued by the nozzles.

The nozzles themselves may be arranged with a multiple of nozzles in the spraying heads such that one spraying head may be able to carry out any other processes desired.

Embodiments of the invention are also directed to method of treating a garment using a treatment cabinet comprising four sidewalls, a top and a bottom enclosing a treatment volume, wherein at least one side wall is openable, allowing aces to the treatment volume, where on the inside of a sidewall facing the treatment volume a spraying device is arranged, the spraying device comprising a curved rail onto which curved rail at least one spraying head is movably mounted such that the spraying head may move along the curved rail, and where the spraying head comprises two or more nozzles adapted to issue a liquid, gas or mist of a treatment agent, and further that the curved rail may move between the top and bottom, guided by side rails arranged parallel to the sidewall, and where means are provided for suspending or supporting a garment inside the treatment volume, where a garment to be treated is positioned on suitable suspension means inside the treatment volume; the access door is closed and a selected treatment regime is selected from a menu; where the selected treatment regime is input to the control unit for selecting treatment compounds, activate nozzles, activation times and durations for nozzles.

In an embodiment, the means provided for suspending or supporting a garment inside the treatment volume comprises a socket and a detachable hanger. The socket has means for engaging the hanger. A flow channel is provided through the socket and to the exterior of the treatment cabinet, the hanger has an engagement section adaptable to detachably engage the means for engaging the hanger provided on the socket. The hanger is (also) provided with a flow channel, which flow channels when the socket and hanger are engaged constitute a continuous flow channel which flow channel in use provides a continuous channel from the inner side of a garment to the exterior of the treatment cabinet.

The hanger provides a well-known and practical means for arranging various garments, such as for example, jackets, coats, blouses, shirts, pants etc. inside the treatment volume. By being arranged on the hanger the items are suspended inside the treatment volume and not in contact with the interior surfaces of the treatment volume, this allows for the treatment agents to unhampered being applied to the entire exterior surface of the garment to be treated.

In an embodiment, a fan is provided in the flow channel, either in the socket or in the hanger. The fan may be operated to create airflow out of or into the treatment chamber. This has influence on the garment and the airflow pattern inside the treatment chamber, and thereby also on the distribution of the mist of treatment agent. Particularly with respect to garments having a design comprising nooks, edges and other non-plane features, the fan provides the possibility of moving the garment during treatment inside the treatment chamber, such that also difficult features to reach becomes better exposed during the treatment cycle.

In an embodiment, the socket is arranged on a movable body installed in the top of the cabinet, where the movable body may move in a horizontal and vertical plane and/or rotate around a vertical axis. This feature further enhances the possibility of exposing the garment arranged on the hanger to the treatment mist.

Embodiments of the present invention will be described with respect to certain drawings, but embodiments of the invention are not limited thereto but only by the claims. The drawings described are only schematic and are non-limiting. Each drawing may not include all of the features of embodiments of the invention and therefore should not necessarily be considered to be an embodiment of the invention. In the drawings. The size of some of the elements may be exaggerated and not drawn to scale for illustrative purposes. The dimensions and the relative dimensions do not correspond to actual reductions to practice of embodiments of the invention.

Furthermore, terms first, second, third and the like in the description and in the claims are used for distinguishing between similar elements and not necessarily for describing a sequence, either temporally, spatially in ranking or in any other manner.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “composing” or “comprising” as used in the claims, should not be interpreted as being restricted to the means listed thereafter; it does not exclude other elements or steps. It is thus to be interpreted as specifying the presence of the stated features, integers, steps or components as referred to but does not preclude the presence or addition of one or more other integers, steps or components or groups thereof.

Similarly, it should be appreciated that in the description various features of embodiments of the invention are sometimes grouped together in a single embodiment, figure, or description thereof for the purpose of streamlining the disclosure and aiding in the understanding of one or more of the various inventive aspects of the disclosure. However, it is not to be interpreted as reflecting an intention that the claimed embodiments of the invention require more features than are expressly recited in each claim.

Furthermore, while some embodiments described herein include some features included in other embodiments, combination of features of different embodiments are meant to be within the scope of embodiments of the invention, as will be understood by those skilled in the art. For example, in the following claims any of the claimed embodiments can be used in any combination.

In the description provided herein numerous specific details are set forth. However, it is understood that embodiments of the invention may be practiced without these specific details. In other instances, well-known methods, structures and techniques have not been shown in detail in order not to obscure an understanding of the description.

### BRIEF DESCRIPTION

Some of the embodiments will be described in detail, with references to the following Figures, wherein like designations denote like members, wherein:

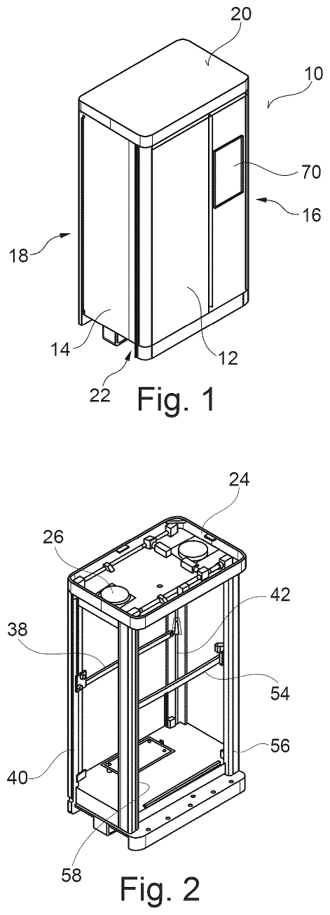

FIG. 1 depicts a treatment cabinet according to embodiments of the invention as it will appear for a user;

FIG. 2 depicts a treatment cabinet where the cover plates are removed exposing part of the interior structure;

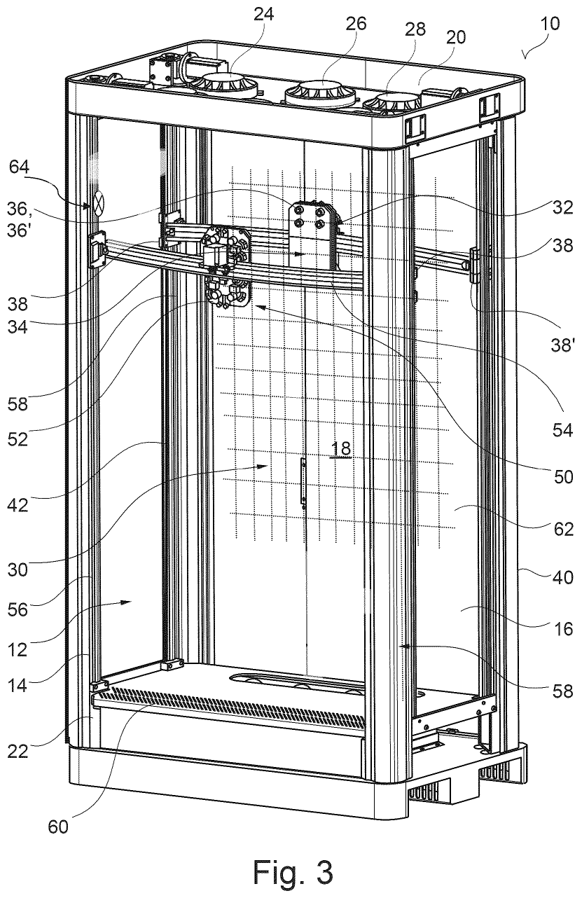

FIG. 3 depicts a treatment cabinet according to an embodiment of the invention;

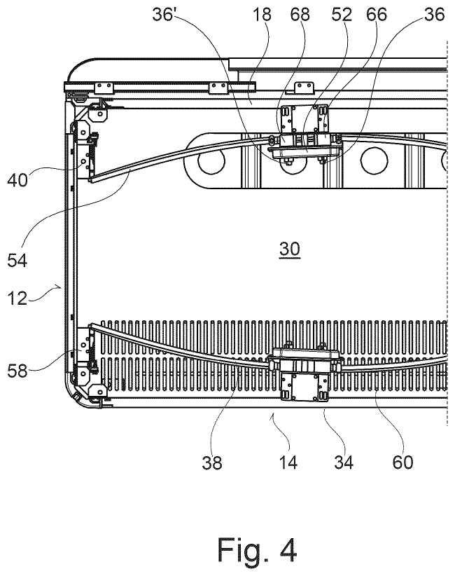

FIG. 4 depicts a top view of the treatment cabinet;

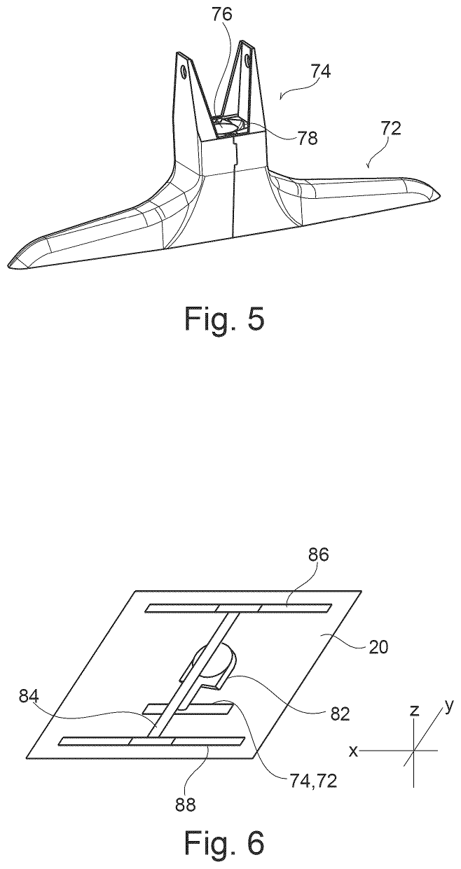

FIG. 5 depicts a hanger/socket construction; and

FIG. 6 depicts a movable body in a top of a treatment cabinet according to embodiments.

### DETAILED DESCRIPTION

With reference to FIG. 1, a treatment cabinet according to an embodiment of the invention is illustrated. The treatment cabinet 10 is provided for four side walls 12, 14, 16, 18 as well as a top 20 and a bottom 22. Together, these four side walls 12, 14, 16, 18 and the top 20 and the bottom 22 enclose a treatment volume 30.

In this embodiment one side wall being the front wall 12 is provided with a user interface 70, here being a touch screen. Other user interfaces may of cause be contemplated such as user-interfaces with buttons, switches etc.

As is indicated in the figure the treatment cabinet is a stand-alone unit.

Turning to FIG. 2 the cladding or panels being the exterior surfaces have been removed to expose part of the interior construction. The indicated features will be further explained below with reference to further figures.

In the embodiments depicted in FIGS. 1, 2 and 3, it is clearly illustrated that the treatment cabinet comprises four side walls which are distinct from each other, but it is also contemplated that two or three of the side walls may be integrated into a curved cross-sectional shape such that the curved shape together with a side wall and a top and a bottom defines the treatment volume 30. At least one of the side walls is openable, in this embodiment the front side 12 is openable allowing access to the treatment volume 30. It is however clear that any sidewall may be designed to be openable, without this feature interfering with the inventive concept of embodiments of the invention.

With respect to FIG. 3 further features of embodiments of the invention will be explained. Inside the treatment volume 30 a spraying device 32 is arranged. The spraying device 32 comprises a spraying head 34 on which spraying head 34, one or more nozzles 36, 36′ are arranged such that the nozzles will spray from the inside of a side wall towards the treatment volume 30.

The spraying head 34 is furthermore mounted on a curved rail 38 where the spraying head may move along the curved rail 38. The curved rail 38 is in either end 38′, 38″ slidingly mounted on side rails 40, 42. In this manner, the curved rail 38 may move, in use vertically along the side rails 40, 42 along the entire treatment volume 30. Likewise, due to the provision of the spraying head's 34 ability to move along the curved rail 38, the spraying head may, due to the movement along the curved rail 38 and the curved rail's movement along the side rails 40, 42, substantially cover an area equal to the entire side wall 18. With this arrangement, a garment arranged inside the treatment volume will be treated on one side of the garment. In order to treat the opposite side, a further spraying device is provided along an opposing side wall. This spraying device 50 also comprises a spraying head 52 mounted on a curved rail 54. This curved rail 54 is like it was the case with the first curved rail 38 also mounted on side rails 56, 58 mounted adjacent the opposing side wall to the first set of side rails. Furthermore, the spraying head is also provided with one or more nozzles. In this manner where the embodiment is arranged inside the treatment volume 30, manipulation of the two spraying devices may create a treatment on both sides of the garment arranged inside the treatment volume 30 simultaneously.

In this embodiment, the top 20 is provided with a number of ventilators or fans 24, 26, 28 which may be operated independently or all together in order to either introduce ambient air into the treatment volume or extract air from the treatment volume 30. By being able to operate the ventilators/fans independently, it is possible to create an air flow inside the treatment volume 30 such that the issued mist of treatment agent from the nozzles of the spraying heads 34, 52 is swirled around the garment to be impregnated whereby an effective use of the issued impregnating agent is obtained. In embodiments where the ventilators/fans 24, 26, 28 are used to extract air from inside the treatment volume 30, a filter unit, not illustrated, will be installed immediately adjacent the ventilation means in order to treat the extracted air. In embodiments where the ventilators/fans introduce ambient air into the treatment volume 30, the bottom 22 is supplied with extraction means in the shape of further ventilators/fans and filters. To this purpose the bottom may be provided with perforations 60 allowing air and impregnating agent to escape to the filter units (not illustrated).

In this embodiment, the side of the rear wall 18 facing the treatment volume is provided with a grid 62. Optical means 64 arranged adjacent an opposite inside wall is arranged to detect which part of the grid is visible when a garment is arranged inside the treatment volume 30 between the optical means 64 and the grid 62. In this manner, it is possible to determine the size of the garment to be treated and adjust the treatment accordingly. In this manner, it is possible to carry out the treatment faster, more precisely and with less waste of treatment compound.

The optical means 64 may further include an ultraviolet sensor such that in embodiments where the treatment compound is provided with a UV reactive backlight agent, the optical means in combination with a UV light may be able to determine to which degree, the garment has been sufficiently covered/treated with the impregnating agent containing the UV reactive backlight agent. This may off course be indicated on an outside screen such that the user immediately will receive an indication of the effectiveness of the treatment and thereby the quality of the treatment.

Turning to FIG. 4, a top view of the treatment cabinet 10 is illustrated, i.e., the top has been removed such that it is possible to look inside the treatment cabinet. As may be seen, two sets of curved rails 38, 54 are provided on opposing side walls with separate spraying heads 34, 52 which can travel independently along the curved rails 38, 54. Likewise, the curved rails 38, 54 may travel vertically i.e., in and out of the figure along the side rails 40, 58.

The spraying heads 34, 52 are provided with directional nozzles 36, 36′ which may be adjusted by adjustment means 66, 68. In this manner, it is possible to direct the nozzles more precisely to the areas where it is particularly desirable to for example impregnate a coat or other garment. This may be done in response to the detection of the size of the coat by the optical means in combination with the grid or from a desire that seams and the like on the garment shall be treated specially and as such by directing the nozzles to these areas, a more intense treatment of for example seams in the garment may be obtained.

Turning to FIG. 5, a hanger/socket construction is illustrated. The hanger 72 is an example of the means provided for suspending or supporting a garment inside the treatment volume 30 comprises a socket 74 and a detachable hanger 72. The socket 74 has means (not illustrated) for engaging the hanger 72. A flow channel 76 is provided through the socket 74 and to the exterior of the treatment cabinet 10. The hanger 72 has an engagement section (not illustrated) adaptable to detachably engage the means for engaging the hanger provided on the socket 74. The hanger 72 is (also) provided with a flow channel 76, which flow channels when the socket and hanger are engaged constitute a continuous flow channel 76 which flow channel in use provides a continuous channel from the inner side of a garment to the exterior of the treatment cabinet 10. The hanger 72 provides a well-known and practical means for arranging various garments, such as, for example, jackets, coats, blouses, shirts, pants etc. inside the treatment volume. By being arranged on the hanger the items are suspended inside the treatment volume and not in contact with the interior surfaces of the treatment volume, this allows for the treatment agents to unhampered being applied to the entire exterior surface of the garment to be treated.

Furthermore, a fan 78 is provided in the flow channel 76, either in the socket 74 or in the hanger 72. In the illustrated embodiment the fan 78 is arranged in the socket 74. The fan 78 may be operated to create airflow out of or into the treatment volume 30. This has influence on the garment and the airflow pattern inside the treatment chamber, and thereby also on the distribution of the mist of treatment agent. Particularly with respect to garments having a design comprising nooks, edges and other non-plane features, the fan 78 provides the possibility of moving the garment during treatment inside the treatment chamber, such that also difficult features to reach becomes better exposed during the treatment cycle.

The socket may be arranged in or on a movable body 82, see schematic illustration in FIG. 6 installed in the top 20 of the cabinet 10. The movable body 82 may move in a horizontal plane defined by the x-y axis and/or vertical plane defined by the axis z-y and/or rotate around the vertical axis z. This feature further enhances the possibility of exposing the garment arranged on the hanger to the treatment mist. The movable body 82 is in this embodiment arranged on a travers rail 84, such that the movable body may move in the y direction along the traverse rail 84. Further the ends of the traverse rail 84 is arranged such that they may slide on further guide rails 86,88, whereby the traverse rail 84 may be moved in the x-direction (in the x-y plane).

Although not illustrated, it is clear that embodiments of the invention also comprise a control unit where different treatment regimes may be pre-programmed depending on what type of garment is to be treated inside the treatment volume 30. The treatment regime may be selected automatically in response to the input from the optical means in combination with the grid such that the control unit independently can determine whether or not it is a coat which is to receive treatment or a pair of trousers, pair of gloves, or the like. Likewise, in embodiments where the treatment compound is mixed with a UV reactive backlight agent, the optical means may as treatment is being undertaken determine the quality of the treatment and continue the treatment until sufficient coverage has been obtained according to already pre-programmed limits or requirements.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A treatment cabinet, comprising four sidewalls, a top and a bottom enclosing a treatment volume, wherein at least one side wall is openable, allowing access to the treatment volume, where on the inside of two mutually facing sidewalls, facing the treatment volume a spraying devices are arranged, each spraying device comprising a rail onto which rail at least one spraying head is movably mounted such that the spraying head is movable along the rail, and where the spraying head comprises two or more nozzles adapted to issue a liquid, gas or mist of a treatment agent, and further that the rail is movable between the top and bottom, guided by siderails arranged parallel to the sidewall, and where means are provided for suspending or supporting a garment inside the treatment volume and where the rails with spray heads are arranged on opposing side walls, and where both sets of rails independently may be moved between the bottom and top inside the treatment volume.

2. The treatment cabinet according to claim 1, wherein the rails are curved, such that the rail is closest to the sidewall in a central part of the rail, and furthest away from the sidewall in the distal ends of the rail(s).

3. The treatment cabinet according to any of claim 1 wherein a grid is provided on one inner surface of a sidewall, and where an optical means is mounted on or near an opposite side, such that the can monitor the grid.

4. The treatment cabinet according to claim 1, wherein on one rail optionally on the spraying head a light source is provided and where on the other rail optionally on the spraying head a light receiver is provided.

5. The treatment cabinet according to claim 3, wherein a control unit is provided, the control unit is programmed with pattern recognition software such that the portion of the grid visible by the optical means or the area where light is received or not received is input to a treatment agent dispenser, determining the amount of treatment agent to be used by the spraying head or heads for treating a particular garment inside the treatment volume.

6. The treatment cabinet according to claim 5, wherein the nozzles are directional, and where the nozzles are arranged to be aimed at certain areas in response to instructions received from the control unit.

7. The treatment cabinet according to claim 3, wherein the vison optical means includes a UV light source and where the treatment agents or one of the treatment agents comprises UV reactive blacklight agent.

8. The treatment cabinet according to claim 1, wherein one or more UV light source(s) is/are provided inside the treatment cabinet

9. The treatment cabinet according to claim 1, wherein ventilation and/or air agitation means are provided in communication with the treatment volume, such that air is being circulated inside the treatment volume, and air comprising surplus treatment agent is ventilated away in a controlled manner.

10. The treatment cabinet according to claim 1 wherein preprogrammed treatment routines are provided in an operators control unit, where the preprogrammed routines may include a sole treatment or a combination of different treatments by having the nozzles issuing a suitable agent towards the garment to be treated, where the treatments may be selected from one or more of the following:
a. chemical cleaning comprising issuing a dry cleaning agent onto the garment to be treated and subsequently removing the cleaning agent;
b. high pressure air jet treatment;
c. impregnation against moisture;
d. bug repellents; and
e. anti-static treatment

11. The treatment cabinet according to claim 1, wherein the means provided for suspending or supporting a garment inside the treatment volume comprises a socket and a detachable hanger, where the socket has means for engaging the hanger, and where a flow channel is provided through the socket and to the exterior of the treatment cabinet, and where ethe hanger has an engagement section adaptable to detachably engage the means for engaging the hanger provided on the socket, and where the hanger is provided with a flow channel, which flow channels when the socket and hanger are engaged constitute a continuous flow channel in use from the inner side of a garment to the exterior of the treatment cabinet.

12. The treatment cabinet according to claim 11, wherein a fan is provided in the flow channel, either in the socket or in the hanger.

13. The treatment cabinet according to claim 11, wherein the socket is arranged on a movable body installed in the top of the cabinet, where the movable body may move in a horizontal and vertical plane and/or rotate around a vertical axis.

14. A method of treating a garment using a treatment cabinet, the treatment cabinet comprising four sidewalls, a top and a bottom enclosing a treatment volume, wherein at least one side wall is openable, allowing access to the treatment volume, where on the inside of two mutually facing sidewalls, facing the treatment volume spraying devices are arranged, each spraying device comprising a curved rail onto which curved rail at least one spraying head is movably mounted such that the spraying head is movable along the curved rail, and where the spraying head comprises two or more nozzles adapted to issue a liquid, gas or mist of a treatment agent, and further that the curved rail may move between the top and bottom, guided by side rails arranged parallel to the sidewall and where rails with spray heads are arranged on opposing side walls also, and where both sets of rails independently may be moved between the bottom and top inside the treatment volume, and where means are provided for suspending or supporting a garment inside the treatment volume, where a garment to be treated is positioned on suitable suspension means inside the treatment volume; the access door is closed and a selected treatment regime is selected from a menu; where the selected treatment regime is input to the control unit for selecting treatment compounds, activate nozzles, activation times and durations for nozzles.
